(19) United States
(12) Patent Application Publication
(10) Pub. No.: US 2016/0195626 A1
(43) Pub. Date: Jul. 7, 2016

(54) Method and System for Determining the Position of Control Devices on a Seismic Instrumented Towed Cable

(71) Applicant: Kongsberg Seatex AS, Trondheim (NO)

(72) Inventors: Arne Rinnan, Ranheim (NO); Ola E. Fjellstad, Trondheim (NO); Per C. Berntsen, Trondheim (NO); Erlend Vaagsholm, Ranheim (NO); Torbjörn Barheim, Trondheim (NO)

(21) Appl. No.: 14/911,129

(22) PCT Filed: Aug. 12, 2014
(86) PCT No.: PCT/NO2014/050143

§ 371 Date: Feb. 9, 2016

(30) Foreign Application Priority Data
Aug. 14, 2013 (NO) 20131111

(51) Int. Cl. G01V 1/38

(52) U.S. Cl. CPC G01V 1/3835; G01V 1/3826

(57) ABSTRACT

A method and system enabling high-accurate determination of the position of control devices in a towed seismic instrumented cable-spread by utilizing absolute and relative position measurements, among others, provided by that the control devices are provided with GNSS-units, and possibly supply of differential correction signals from a high-accurate positioning source onboard the survey vessel by means of data transfer in the instrumented cables or via radio directly to the control devices when they are in surface position.

### BACKGROUND

The disclosure is related to a method for determining the position of control devices on a seismic instrumented towed cable. Also disclosed herein is a system for determining the position of control devices on a seismic instrumented towed cable.

More particularly, the disclosure is related to a method and system for using a combination of satellite-based navigation systems and integrated sensor systems for determining the position of a seismic instrumented cable.

Particularly, the disclosure is also related to a method and system where the control devices are provided with detachable wings, where all the sensors are assembled in the wing, alternatively the control device is provided with several wings with sensors for redundancy.

A seismic instrumented cable (streamer) is an elongate cable-like structure (often up to several thousands meters long), which comprises an array of hydrophone cables and associated with electric equipment along its length, and which is used in marine seismic surveying. In order to perform a 3D/4D marine seismic survey, a plurality of such instrumented cables is towed behind a seismic survey vessel. Acoustic signals are produced by that the seismic sources are directed down through the water and into the seabed beneath, where they are reflected from the various strata. The reflected signals are received by the hydrophone cables, and next digitized and processed to form a representation of the earth strata in the area being surveyed.

The instrumented cables are typically towed at a constant depth of about five to ten meters, in order to facilitate the removal of undesired “false” reflections from the surface of water. In order to keep the instrumented cables at a constant depth, control devices known as “birds” are attached to each instrumented cable at intervals of 200 to 300 meters.

Low frequency depth variations and lateral motions are inevitable. The main reason for instrumented cable depth variations is long periodic waves and changes of salinity and thus buoyancy along the cable. In general, the worst-case situation is when towing in the same direction as the swell. Instrumented cable lateral motions are mainly due to sea current components perpendicular to the towing direction. Relatively large deviations can also appear in areas with brackish water where river course flows into the sea, something which can result in water stratification with different density. In cases of both swell and crosscurrent influences, the risk of streamer entanglement is increased.

The instrumented cable tension decreases proportionally to the distance from the towing point. Therefore, low frequency instrumented cable lateral and vertical motion tend to have larger amplitudes closer to the tail. However, the forces acting perpendicularly to the instrumented cable are non-uniformly distributed over the instrumented cable length, and change over time as the towed array moves forward.

During a seismic survey, the instrumented cables are intended to remain in a straight line, parallel to each other, equally spaced and at the same depth. However, after deployment of the instrumented cables, it is typically necessary for the vessel to cruise in a straight line for at least three instrumented cable lengths before the instrumented cable distribution is approximately close the ideal arrangement and the survey can begin. This increases the time it takes to perform the survey, and therefore increases the cost of the survey. However, because of sea currents, the instrumented cables fail to accurately follow the path of the seismic survey vessel, and sometimes deviating from this path at an angle, known as the feathering angle. This can result in that it in some areas are not covered by the seismic signals and that it thus occurs holes in the survey of the seabed, frequently requiring that certain parts of the survey be repeated. In extremely unfortunate circumstances, the instrumented cables can become entangled, especially at the tail of the instrumented cables, something which can cause great damages, long alignment time and considerable financial loss.

To counteract these disadvantages control devices are developed which can control the instrumented cable also laterally, either alone or possibly in combination with vertical control. To be able to control the instrumented cables in the best possible way, both vertically and laterally, it is essential that the position and shape of the cable can be determined accurately. E.g. NO 20080145 describes a control device with three detachable wings where electronics, control unit, sensors and batteries are arranged in the wings, which provides a novel and accurate control opportunity in relation to other methods.

The information about the accurate position of the cable is further important for correct analysis of the seismic signals. High accuracy of the position of the cable results in high quality of the seismic data. In other words, it is extremely important to determine all points of the cable with as high accuracy as possible.

It is further known methods for controlling instrumented cables (streamers) which include the use of devices specially dedicated for position determination, such as GNSS-units (receiver+antenna) (GNSS-Global Navigation Satellite System) arranged on units being towed at surface position, and magnetic compass and acoustic transducers arranged externally on the instrumented cables hydrophones. Extra units arranged externally on the instrumented cables have the disadvantage that they sometimes are lost or becomes damaged due to the instrumented cables become entangled or in connection with other collision situations, and that they result in flow noise on adjacent seismic instrumented cables. In addition, such units are powered by batteries which need to be exchanged at given intervals, and by that they need to be calibrated, repaired and exchanged, this is something which results in increased costs and time consumption.

From U.S. Pat. No. 5,761,153 it is known the use of both magnetic compass and acoustic transmitter and receiver units, but these are arranged externally on the instrumented cables, something which makes them exposed to damage, as mentioned above.

From U.S. Pat. No. 4,992,990 it is known use of acoustic transmitter and receiver units arranged along the entire instrumented cable. Position is determined by trilateration of transfer time (and accordingly the distance) between transmitter and receiver elements to form a triangular network, where two known positions are used, preferably position for vessel and float, while the transmitter and receiver unit is the third position being calculated in the triangular network. This way of doing it is attended with problems if mechanical or electrical faults occur in hydrophone cables or other locations in the system. This publication also has the same disadvantages as described above as regards externally arranged transmitter and receiver units.

From U.S. Pat. No. 4,912,682 it is known the use of ultrasonic sonar transmitters and seismic receivers positioned along the instrumented cable, where there are three times as many receivers as transmitters. However, this publication does not solve the disadvantages mentioned for the publications above.

U.S. Pat. No. 6,839,302 describes a solution of the above-mentioned problems by proposing a special section which can be arranged between traditional sections of the instrumented cable. However, this solution is expensive and work demanding, and in addition can result in limited data redundancy and quality as it limits where the transmitter and receiver units can be arranged.

In U.S. Pat. No. 7,376,045 it is described a system which includes numerous acoustic transmitters arranged inside the instrumented cables and arranged for transmitting broadband signals with low cross-correlation between the signals from different transmitters; numerous receivers arranged inside the instrumented cables and arranged for receiving the signals from the transmitters; at least one processor arranged for cross-correlating the signals received at the receivers, with copies of the transmitter signals for determining identities of the transmitters of the received signals for determining propagation times for the received signals; and a main processor arranged for transforming the propagation times to distances between the identified transmitters and receivers and for determining relative positions of the instrumented cables from the distances. A considerable disadvantage with U.S. Pat. No. 7,376,045 is that it requires that the transmitter and receiver elements are arranged inside the instrumented cable and this is something being space-demanding in an instrumented cable. Another disadvantage is that if mechanical or electrical fault occurs at the transmitter and receiver elements, the entire section of the cable must be exchanged. In addition, the distance from where the position is calculated will be different from the position where the control device is arranged, something which can result in an inaccurate controlling of the instrumented cable.

U.S. Pat. No. 2004/0073373 A1 describes a solution where inertial sensors arranged along the cable are used for estimating the position of the cable after deployment. Initial position is determined from e.g. GNSS-sensors aboard the vessel before deployment. The disadvantage with this solution is that the position estimate based on the inertial sensors will deviate already after short time after deployment, and it is not practically possible to wind the cable in and out again for reinitializing.

U.S. Pat. No. 7,190,634 B2 describes a solution where surface units are equipped with GNSS-units and acoustic positioning equipment is towed in addition to the instrumented cables. The cables are also equipped with acoustic receivers so that relative position of the towed surface units can be measured/calculated. The disadvantage with this solution is that the position estimate of the acoustic nodes on the cable will always be inaccurate, as a consequence of relatively long distance between the surface units and the acoustic nodes.

U.S. Pat. No. 2008/0253225 A1 describes a solution where inertial sensors arranged along the cable are used in an integrated filter with acoustic ranges to estimate position of the cable relative at least one known point, where the known point typically is a surface unit with GNSS-unit and acoustic transducers. The disadvantage with this solution is that the filter positions in the nodes of the cables become inaccurate due to the long distance between the GNSS-reference and inertial/acoustic sensors.

U.S. Pat. No. 2013/0033960 A1 describes a solution where the tail buoy at the end of the cable can be dived down and partly used for controlling the cable vertically and laterally when it is submerged. The disadvantage with this solution is that it only provides few position reference points for the cable spread when the tail buoys are in a surface position.

EP 2 527 880 A2 describes a solution where remotely submergible units are towed, typically in front or at the end of the instrumented cables, so that GNSS-positions can be updated regularly for re-initialization of e.g. inertial/acoustic based position filter in nodes along the cable. The disadvantage with this solution is that it only provides few position reference points for the cable spread when the remotely controlled units are in surface position.

EP 2 229 596 describes a solution where the control device is provided with acoustic transducers in one or more of the detachable wings for reducing the need for additional positioning equipment along the instrumented cable, and at the same time co-localization of control device and positioning equipment is achieved, which can be used for decentralized lateral control logic. The disadvantage with this solution is that it is a long distance between the acoustic nodes and the absolute GNSS-based position reference points on tail buoys, seismic source-array and survey vessel.

From U.S. Pat. No. 2013182531 A1 it is known marine seismic surveying with towed components below water surface, wherein is described the use of controllable deployed vehicles provided with GPS receiver which can be brought to the surface for determining of position and velocity of the controllable deployed vehicle.

U.S. Pat. No. 2010118645 A1 describes a method and apparatus for controlling streamer steering devices to maintain a coil streamer shape that gives coverage for a coil shooting plan by using differential GPS for determining positions of the streamers.

A problem reducing the accuracy of the positioning is that the accuracy of the sensors being used for measuring the position of the instrumented cable varies or are inaccurate. Usually, acoustic positioning of control devices in relation to each other is used, by means of each control device being provided with acoustic transmitters and receivers which make it possible to estimate the distance between the control devices. Acoustic positioning accuracy will decrease with the distance to absolute position references, and especially in the area around the middle of the cable spread the strength of such an acoustic network will be limited.

Known systems using GNSS-data usually consist of GNSS-receivers in following vessel and with radio transmission in to the survey vessel. The disadvantage with these systems is, first of all, that the number of positioning points becomes low, typically 2-3 positioning points per instrumented cable. Further, these positions are linked to the following vessel and towing vessel and says nothing about how the instrumented cable is positioned on the stretch between the vessel and following vessel. As waves and underwater currents can result in considerable displacement of the instrumented cable it can be a considerable difference between the position of the instrumented cable and the straight line between vessel and following vessel, which can be located several kilometers behind the vessel. Further, during maneuvering and in connection with turn, there will be insecurity with regard to the accurate positioning of the cable based on the position of the following vessel.

### SUMMARY

Provided herein is a method and system which partly or entirely solves the disadvantages of prior art.

Also provided is a method and system for achieving high-accurate positioning of seismic instrumented cables by means of satellite-based navigation systems and integrated sensor systems arranged in connection with control devices of the cable. Hereunder is an object to achieve high accuracy by using absolute and relative position measurements, and possibly supply of differential correction signals from a high-accurate positioning source onboard the survey vessel.

Also provided is a method and system for co-location of all sensors in wings of the control device, hereunder integration of a GNSS-unit (Global Navigation Satellite System) in one or more wings of the control device.

Also provided is a method and a system which enables removal of tail buoys for a seismic instrumented cable spread.

Also provided is a method and system for utilization of independent inertial clusters in wings of the control device for redundancy, which can be used for integrity evaluations, and improved positioning accuracy for each control device as a whole.

Also provided is a method and system where arbitrary or chosen control devices can be elevated to the surface for obtaining position from satellite-based positioning systems.

Also provided is a method and system where position data or attitude data from each control device can be used for calculating shape of the cable.

Also provided is a method and system arranged for online calibration of sensors of the system.

As disclosed herein, a method and system are provided which enable high-accurate determining of the position of control devices in a towed seismic instrumented cable spread by using absolute and relative position measurements, and possibly supply of differential correction signals from a high-accurate positioning source onboard the survey vessel by means of data transfer in the instrumented cables or via radio directly to the control devices when they are in surface position.

A typical system for positioning an instrumented cable towed in water, such as a marine seismic streamer, and/or a towed instrumented cable-array (streamer-array), includes control devices with wings arranged for controlling the individual instrumented cable both in shape and position in relation to other instrumented cables, and thus counteract crosscurrents and/or other dynamical forces acting on a instrumented cable-array towed behind a towing vessel, preferably a seismic survey vessel. A typical system further usually includes a control central arranged onboard the (survey) vessel, which control central is arranged for communication with the instrumented cables and the separate control devices arranged thereto. This is often referred to as a STAP-system (STAP-“Seismic Towed Array Positioning”). Known systems for this further includes tail buoys arranged to each of the instrumented cables in the cable-array, something the disclosed method and system avoid by replacing the tail buoy with control devices, something which will be further described below. A typical system will further include deflector devices for spreading the instrumented cables in a cable-array. The control central is further arranged for communication with the vessel and possibly the deflector devices.

A control device includes:

a main body provided with minimum one processor unit, and inductive connections for wireless (contactless) communication and energy transfer to wings or mechanical connections for communication and energy transfer;

wings, preferably three detachable wings, said wings minimum being provided with a processor unit, inductive connection or mechanical connection for connection to the main body, Hall effect sensor, rechargeable batteries, intelligent charging electronics, motor with gear;

local control device software executing on the processor unit of the main body;

local wing control software executing on the processor unit of the wing.

The disclosed method and system further include integration of a GNSS-unit (receiver+antenna) (Global Navigation Satellite System) in at least one wing of at least one control device on each instrumented cable. By bringing the control device in surface position one can thus achieve accurate GNSS-position while the control device is in surface position. Further, numerous control devices can be provided with a wing with GNSS-unit so that one obtains many position reports which can be correlated with each other. The position data can further be corrected by means of differential corrections being derived from a high-accurate position receiver onboard the vessel. Differential corrections from other external sources can also be used. By bringing the control device up to the surface, at least the wing being provided with GNSS-unit, the position of seismic cables can be controlled.

As mentioned above, at least one control device for each instrumented cable is provided with a GNSS-unit in at least one of the wings thereof, preferably such that the antenna of the GNSS-unit is arranged in the wing tip farthest from the main body, and preferably in another wing than wings including acoustic communication means (further described below). Such control device with GNSS-unit in at least one wing is preferably arranged at the back of the spread for replacing the tail buoy, and one control device with GNSS-unit in wing mainly close to the middle of the instrumented cable. In a maximal embodiment are all the control devices provided with a GNSS-unit so that each control device in the spread can be positioned by means of satellite signals. As the control devices are typically located approximately 200-300 meters from each other, information about the entire spread and position of each instrumented cable can be established for each 200-300 meters along the cable.

Being able to remove the tail buoy from the spread is advantageous as the entire spread then is submergible, something which results in that the spread avoids ice, boats or other objects floating in the surface.

By that the control device has at least one wing with GNSS-unit absolute position and velocity can be measured when this is brought to surface position. It is thus advantageous that the control device is arranged for controlling the wing with the GNSS-unit to point mainly straight upwards so that it extends above the sea surface and in this way can detect GNSS-satellites in Line-of-Sight. The antenna of the GNSS-unit is preferably arranged in the wing tip so that affection from sea spray as little as possible interfere the signals from the GNSS-satellites. A GNSS-antenna fixed to the main body independently of the wings is also a possible solution, but will result in considerable mechanical disadvantages due to additional drag and in relation to acoustic noise. In addition it will be exposed to sea spray interfering the signals from the GNSS-satellites, as it will not have sufficient extension above the water surface.

To shorten the acquisition time for position and velocity determination one may, according to the disclosed embodiments, download orbital data for the satellites, clock and approximate position, aiding data, to the receiver of the GNSS-unit in the control device. These aiding data are normally continuously available at the towing vessel as a part of its positioning systems, and can be distributed to the control devices either via the instrumented cables, or via radio transfer in surface position if the wing with the GNSS-unit in addition is provided with a radio unit (further described below). In this way the time the control device needs to be in surface position can be reduced to a minimum so that it rapidly can dive back to operational depth.

Further, arranging the GNSS-unit and the other sensors in detachable wings is favorable with regard to that they are easy to exchange at fault, and it provide opportunities for redundancy and use of back-up equipment.

In addition to the above-mentioned GNSS-unit it is preferable that at least one wing of each control device is provided with acoustic communication means in the form of an acoustic transducer and transmitter/receiver electronics so that distance to at least one adjacent control device can be measured when the relevant wings are submerged. When the control device is in surface position it is advantageous that at least one wing with acoustic transducer is pointing downwards so that it is submerged in the sea with regard to continuing the range measurements. Each control device can be pre-configured to be either a transmitting node or a receiving node.

Range measurements by means of acoustic, according to the disclosure, may be performed by measuring the time it takes for an acoustic signal to travel from a transmitting node to a receiving node. The range measurements are preferably initiated by a synchronization signal from the towing vessel via the instrumented cable to all the control devices. At synchronization the transmitting nodes will transmit an acoustic signal with its own signature and the receiving nodes measure the time difference between the synchronization signal and the point in time they receive the acoustic signal. The receiving nodes then send all measured pseudo-ranges (time differences) to the towing vessel via the instrumented cable, where telemetric network calculations are performed to determine relative positions for each node (control device).

The towing vessel is also a node in the acoustic network so that the absolute positions of the nodes can be calculated from the relative positions and navigation data of the vessel.

The absolute node positions are next sent back to each control device and go in as a posteriori updates of integrated position filters (further described below) locally in each node (control device).

Each control device is further preferably provided with at least one wing with a three-axis magnetometer and inertial cluster; i.e. accelerometer and possibly rate gyros. If one assumes that the orientation (roll-pitch-course) of the control device will be relatively static, the rate gyro can be dropped.

It is advantageous to arrange the magnetometer in the wing tip to position it as far away as possible from the magnetic stray field generated by varying current through the main body of the control device. The inertial cluster can in principle be arranged anywhere.

By combining inertial data and magnetometer data the orientation of the wing relative a earth-fixed coordinate system can be calculated, and thus also the acceleration of the control device in the same global reference frame.

Having the magnetometer and inertial cluster arranged in detachable wings is advantageous with regard to that they are easily exchangeable at faults, and this provides opportunities for redundancy and use of back-up equipment.

An alternative arrangement in the wing is that only the magnetometer is arranged in the wing and that the inertial cluster is arranged in the main body of the control device. However, this results in that measured magnetic field must be aligned with the inertial cluster before magnetometer data and inertial data can be mixed to find orientation of the control device. Such alignment includes compensation for wing base angle relative the main body, and dynamic deflection of the wing for controlling the movements of the control device.

Acceleration calculated in global reference frame can be used together with position and velocity data from either GNSS or acoustics in an integrated position filter locally in the control device. A local optimal, continuous and smoothed position determination of each node (control device) in the instrumented cable spread can thus be achieved.

GNSS-position and velocity of the control device can be used to initialize the integrated position filter at deployment of the control device, when the control device hangs in the air behind the towing vessel.

Re-initialization of the integrated position filter from GNSS-position and velocity of the control device can be made after need by bringing the control device to surface position as described above.

GNSS-position and velocity of the control device can be used in combination with acoustic measurements if the wing provided with GNSS-unit pointing upwards of the sea; i.e. is in air, at the same time as one wing provided with acoustics is pointing downwards; i.e. is submerged in water. In this way GNSS-positions and velocities can be used to calibrate the sound velocity in water. Sound velocity will generally be derived by least square method based on redundant acoustic range measurements. By means of previous knowledge about in-line distances between the nodes this can be used together with in-line range measurements to tighten the sound velocity estimate. Further, reflections from water surface or seabed provide acoustic range measurements, which can be used for integrity/calibration of depth sensor (such as an echo sounder).

In submerged position it is position from the acoustic positioning system which constitutes a posteriori-update of the integrated position filter.

The position accuracy in the acoustic network will typically decrease with distance to absolute reference; in this case the towing vessel. It will thus be natural that control devices far back on the instrumented cable must more often be brought up to the surface for re-initialization with GNSS-signals than the control devices near the front.

The control devices/nodes will accordingly calculate its orientation (roll, pitch, course) based on inertial and magnetometer data, after which the orientation of the nodes can be used in a central calculation on the vessel to estimate the shape of the instrumented cable. This estimate can either be used for improving/validating position data of the node, or as a separate redundant positioning system if the acoustic network should not work.

A control device as disclosed herein can further include accelerometers, rate gyro and/or pressure sensor, preferably arranged in the main body, but can also be arranged in one or more of the wings of the control device for achieving sensor redundancy.

A control device as disclosed herein can further preferably include a radio unit (antenna+radio receiver) for data transfer, preferably arranged in a wing with GNSS-unit, preferably such that the radio antenna is arranged at the side of the wing pointing forward (in towing direction/towards the towing vessel), which radio unit is arranged for data communication between the control device and the towing vessel, work boats or similar.

A 3D/4D instrumented cable spread usually consists of 6-12 km long instrumented cables being towed by a towing vessel so that the instrumented cables become lined in parallel behind the vessel with 50-100 meters mutual distance.

For controlling the instrumented cables in depth and laterally the above described control devices are arranged along each instrumented cable, with approximately 200-300 meters mutual distance between two adjacent control devices. The control devices can be arranged outside the instrumented cable, but preferably the control devices are of the kind which can be arranged in-line between two cable sections, where the wings of the control devices are arranged for controlling the instrumented cable vertically and horizontally. According to the disclosure there is a co-location of position and movement sensors in one or more of the wings of the control device, so that it higher accuracy and accessibility of position data for the control devices can be achieved, and thus the instrumented cables, compared to existing solutions. Another advantage with the disclosed embodiments is, as mentioned, that a control device on the tail of an instrumented cable with the proposed equipment could replace present tail buoys and make deploying/retrieving of instrumented cables simpler and safer for operators on deck. An instrumented cable without tail buoy can be completely submerged the most of the time. Arrangement of a control device on the tail which can be controlled vertically and laterally will also make it easier to avoid that the cable tails get entangled with each other.

At deployment of an instrumented cable the control devices will typically get detachable wings mounted while the control device is still on deck. When the control device with wings is spooled over the rail of the vessel, it will hang in the air for a short time before it penetrates the sea surface. In this period GNSS-satellites will be visible for the GNSS-unit in the wing(s) so that the global position of the control device can be determined. This position will be used for initialization of the local integrated position filter in the control device which is an integration of position and acceleration data.

As the control device increases the distance to the vessel and becomes submerged in the sea, it loses position data from GNSS. The integrated position filter is then updated ballistically with acceleration data (a priori data) until new position data are available. In submerged state it is the acoustic range data from the control devices combined with global telemetry on the vessel which provides new a posteriori position data to the integrated position filter. Usually, acoustic position data will be available approximately each 5 seconds so that the deviation in the local integrated position filter is limited in the ballistic period.

Over time the position estimate for the control devices (nodes) will be deteriorated even if acoustic position data are continuously available, especially is this related to the control devices (nodes) farthest back and being farthest from the global reference from the navigation data of the vessel. It is then an advantage to bring some control devices (nodes) to the surface for re-initialization of the integrated position filter with GNSS-position and velocity. This can either be done regularly or more preferably based on operational considerations. While seismic is produced it will be severe limitations of how the control devices can operate, so that such re-initializations in surface position will typically be performed when the vessel is not in line and fires seismic. Alternatively one can think that one actually desires a tightening of the position estimates even if one lies and fires seismic in a line. This can be performed by that the entire or parts of an instrumented cable is brought to the surface at the same time as the instrumented cables on each side of the relevant cable are brought closer laterally, so that geographic holes in the seismic data occur, as data from instrumented cables at the surface cannot be used.

If the acoustic position data are not available for a long time the integrated position filter will gradually drift outside acceptable limits for position accuracy. The magnetometers in the wings in combination with inertial data could provide the orientation of the control device continuously, and these will in such a situation make it possible to estimate the shape of the instrumented cable and thus position, even without direct position measurements. This property can also be used onboard the vessel for improving or validating the position estimates which comes from the position filter of the control device and/or the position estimates from the acoustic telemetry calculations.

Further preferable features and details will appear from the following example description.

### BRIEF DESCRIPTION OF THE DRAWINGS

The disclosed embodiments will below be described in further detail with references to the attached drawings, where:

FIG. 1 is an example of an embodiment of a control device according to the disclosure,

FIG. 2 shows a control device arranged at the tail of an instrumented cable,

FIG. 3 shows GNSS-position determination of an arbitrary control device,

FIG. 4 shows position filter for control devices,

FIG. 5 shows acoustic range measurements between control devices, and

FIG. 6 shows signal flow in the system.

### DETAILED DESCRIPTION

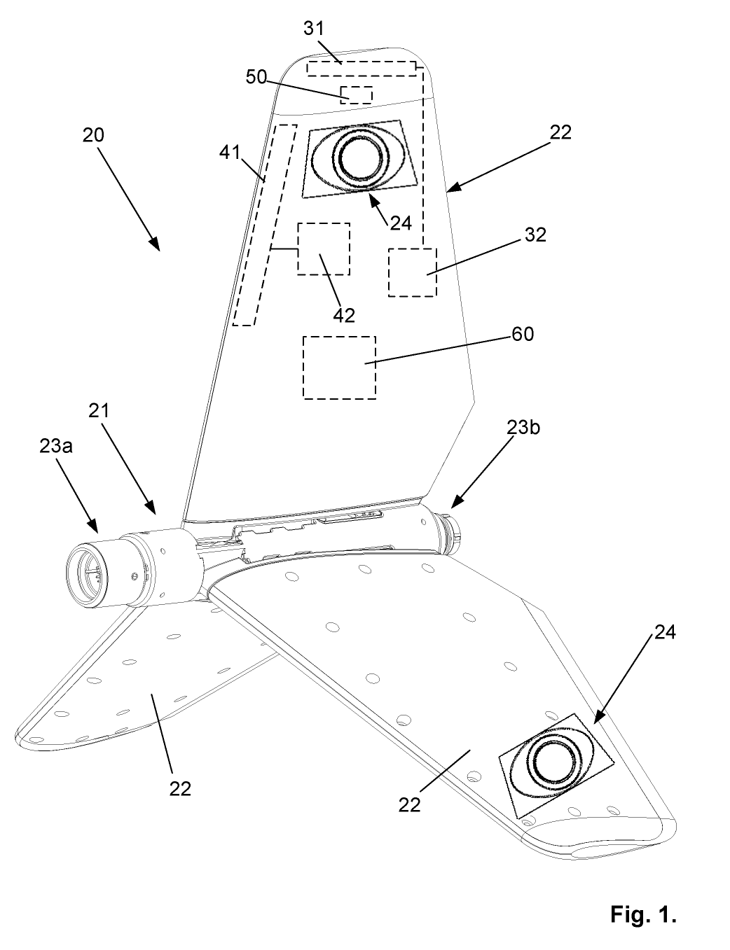

Reference is now made to FIG. 1 which shows a principle drawing of an example of an embodiment of a control device 20. The control device 20 is arranged for connection in series between two adjacent cable sections 50a of a multi-section cable 50, for controlling the instrumented cable 50.

The control device 20 is formed by a main body 21 and three wings 22, preferably so-called smart wings, which are evenly distributed around the main body 21, and is a so-called three-axis bird. The main body 21 is mainly an elongated streamlined tubular housing, which at its ends includes connection means 23 and 23b adapted for mechanical and electrical connection in series in a multi-section seismic instrumented cable 50, of the type being towed behind a seismic survey vessel 100. The connection means 23a and 23b are for this adapted corresponding connection points (not shown) at each end of each cable section, which connection points usually are used for connecting two adjacent cable sections 50a. The wings 22 are further detachably arranged to the main body 21.

The main body 21 is further provided with a processor unit (not shown), pressure sensor (not shown), and three inductive connections (not shown) for wireless communication and energy transfer to wings 22 or three mechanical connections (not shown) for communication and energy transfer.

The wings 22 are provided with a processor unit (not shown), inductive connection (not shown) for connection to the main body 21 for communication and energy transfer, Hall effect sensor (not shown), chargeable buffer batteries (not shown), intelligent charging electronics (not shown), and motor with gear for controlling the wings 22.

Further, at least one of the wings 22 is provided with acoustic communication means 24 in the form of a transmitter/receiver element, in the form of a transducer, and provided with electronics for acoustic range measurement.

The control device 20 further includes a GNSS-unit (Global Navigation Satellite System) consisting of a GNSS-antenna 31 and a GNSS-receiver 32 arranged in at least one wing 22 of the control device, where the GNSS-antenna 31 preferably is arranged in the wing tip.

The control device 20 further preferably includes a radio unit for data transfer consisting of a radio antenna 41 and a radio receiver 42 arranged in at least one wing 22 of the control device, where the radio antenna 42 preferably is arranged along the edge of the wing 22 facing forward, i.e. in the towing direction.

A control device 20 preferably further includes a three-axis magnetometer 50 in at least one wing 22 of the control device, which magnetometer 50 preferably is arranged close to the wing tip.

The control device 20 further preferably includes an inertial cluster 60 (IMU) including one or more accelerometers (not shown) and possibly rate gyro (not shown), which inertial cluster 60 is arranged in at least one wing 22 of the control device 20.

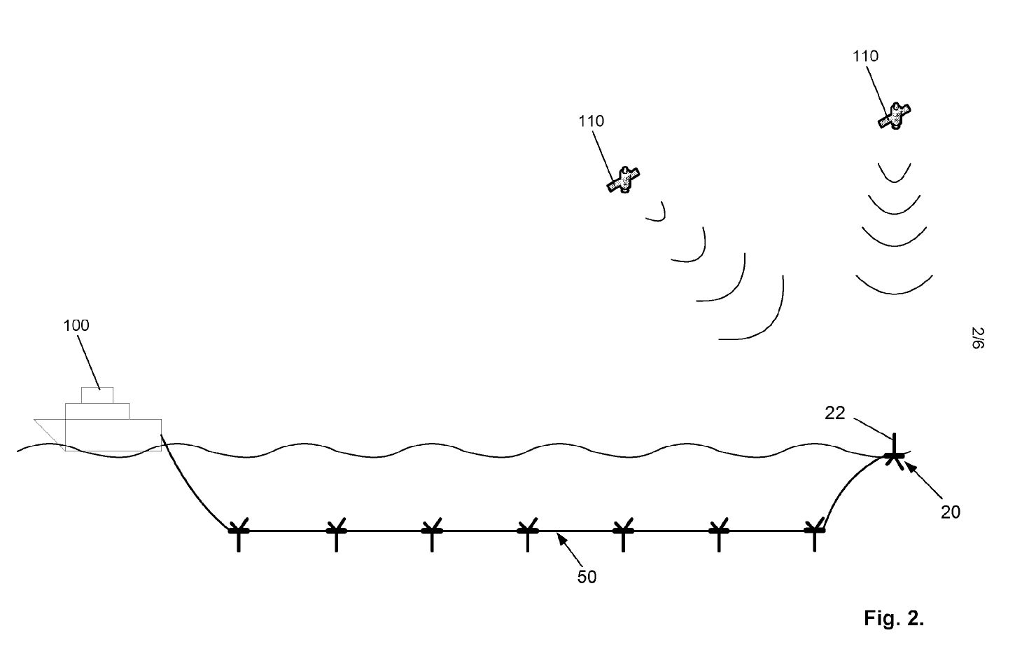

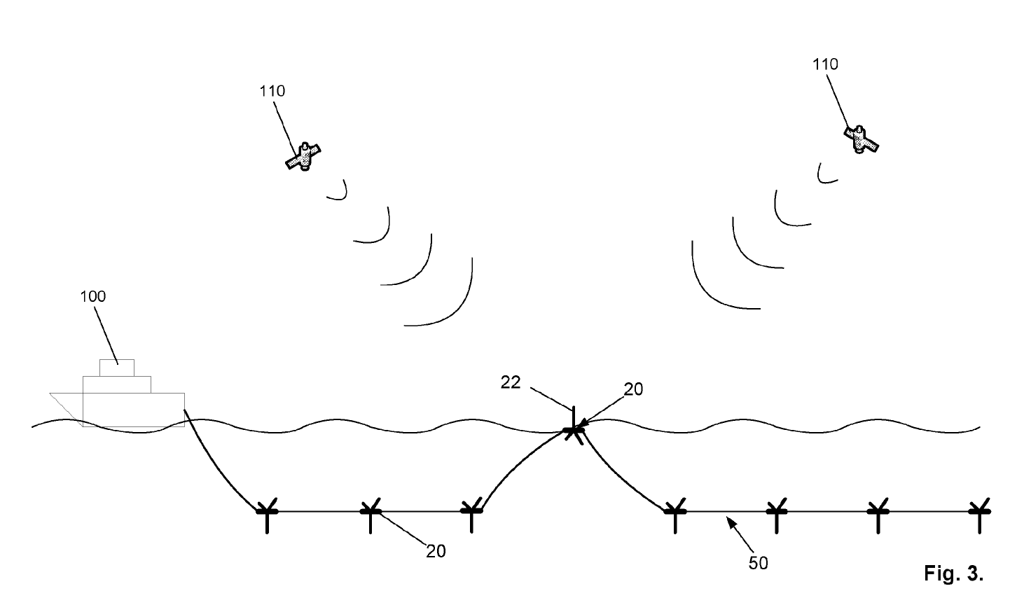

Reference is now made to FIG. 2 which shows how GNSS-position can be collected for a control device 20 being arranged for replacing the tail buoy for each instrumented cable, and FIG. 3 which shows how GNSS-position can be collected for an arbitrary control device 20.

By bringing the control device 20 up to surface position by arranging one wing 22 of the control device provided with GNSS-unit such that it protrudes mainly straight up from the surface, the antenna 31 of the GNSS-unit will achieve contact with GNSS-satellites 110 in line-of-sight and therethrough during a limited time be able to determine position and velocity for the control device 20 before it is brought down to operational depth again. When the control device 20 is in this surface position it can further use the radio unit for data transfer to/from the control device, which can be used for collecting orbit data for the GNSS-satellites 110 for therethrough achieving more rapid determination of the GNSS-position, or for communication with work boats. How the GNSS-position and radio communication are used will be described in further detail below.

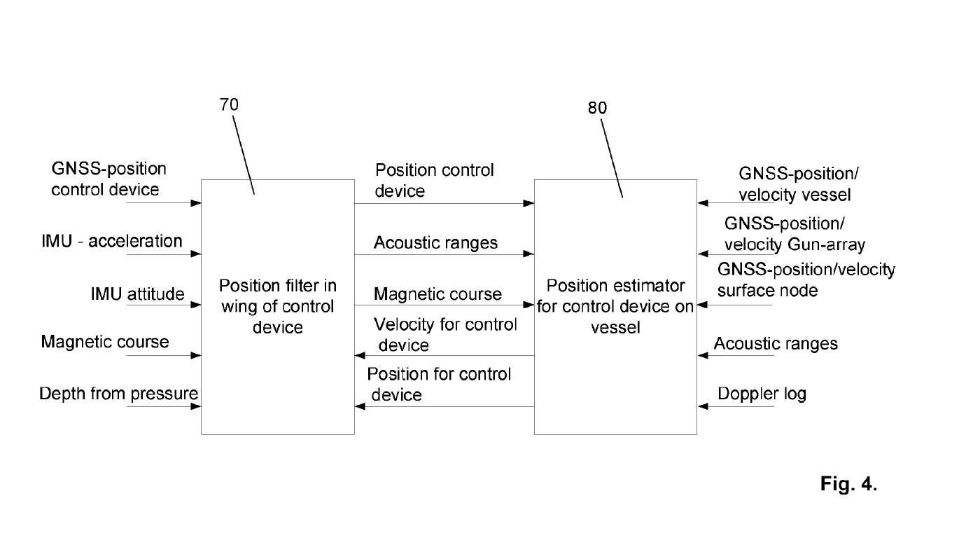

Reference is now made to FIG. 4 which shows an integrated position filter 70, which position filter is integrated in the processor unit of the wing 22, and the interaction with a position estimator 80 for control device arranged in a control central of a vessel. Input to the integrated position filter 70 from the control device 20 itself will be GNSS-position acquired from the GNSS-unit as described above, acceleration and attitude acquired from the inertial cluster 60, magnetic course (heading) from the magnetometer 50, and depth from a pressure sensor arranged in main body 21 or wing 22 of the control device. In addition the integrated position filter 70 is arranged for receiving input from the position estimator 80 arranged in the control central of the vessel in the form of velocity and position for the control device 20. Output from the integrated position filter 70 will be estimated position for the control device 20, attitude and magnetic course (heading), and acoustic ranges (further described below). The position estimator 80 will typically have input about GNSS-position and velocity for the vessel acquired from satellite positioning systems onboard, GNSS-position and velocity for Gun-array, GNSS-position and velocity for other surface nodes which are a part of the system, acoustic ranges both in relation to control devices/nodes under the surface and possibly surface nodes being a part of the system, and Doppler log.

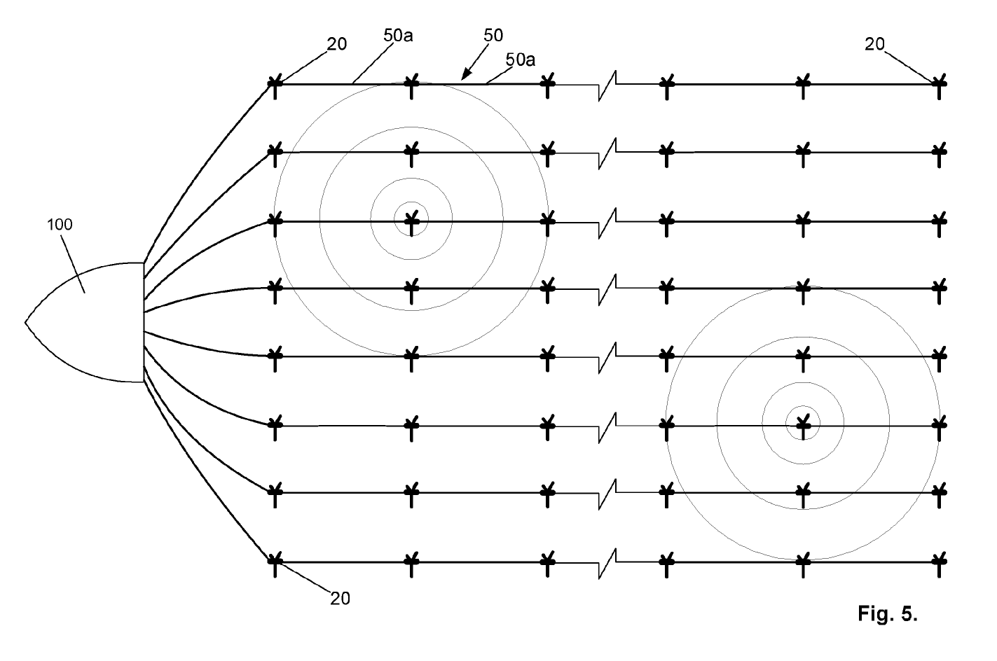

Reference is now made to FIG. 5 showing execution of range measurements by means of the acoustic communication means 24. The range measurements are performed by measuring the time it takes for an acoustic signal to travel from a transmitting control device 20 to a receiving control device 20. The range measurements are preferably initiated by a synchronization signal from the towing vessel 100 via the instrumented cable 50 to all the control devices 20. At synchronization the transmitting control devices 20 will transmit an acoustic signal with its own signature, and the receiving control devices 20 will measure the time difference between the synchronization signals and point in time they receives the acoustic signal transmitted from the transmitting control devices 20. The receiving control devices next sends all measured pseudo-ranges (time differences) to the towing vessel 100 via the instrumented cable 50, where telemetric network calculations are performed for determining relative positions for each node (control device). By that the towing vessel 100 also is a node in the acoustic network the absolute positions of the nodes (control devices 20) can be calculated from the relative positions and navigation data of the vessel 100.

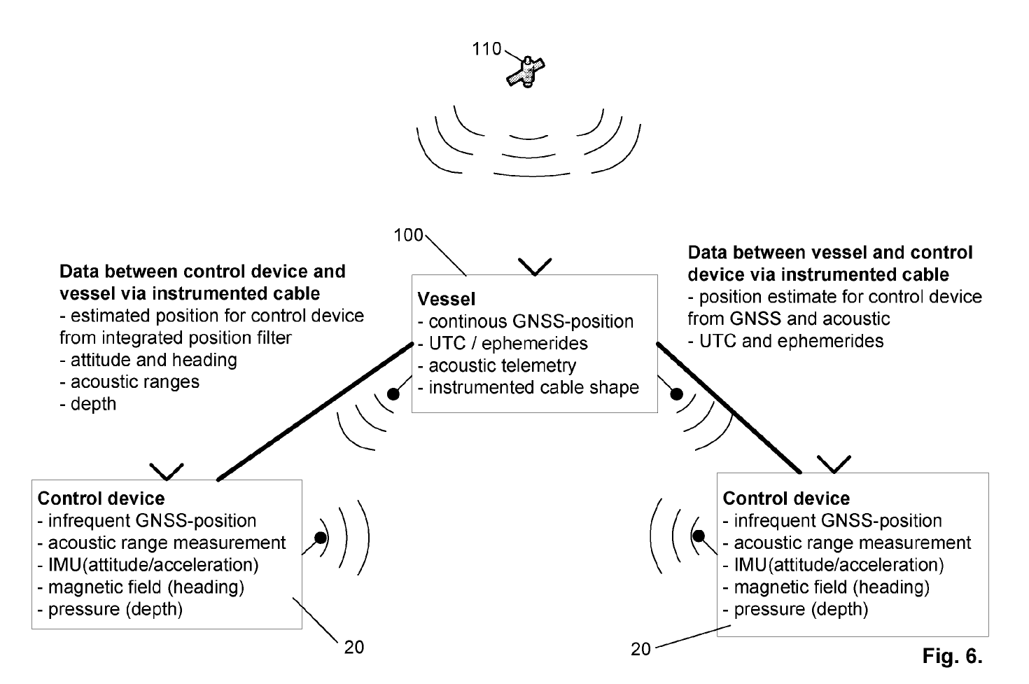

Reference is now made to FIG. 6 which shows the signal flow in the system. As mentioned above the control device 20 is arranged for finding GNSS-position, perform acoustic range measurement, finding attitude and acceleration, course (heading), and depth, which results in that the control device 20 can send estimated position for the control device 20 from the integrated position filter 70, attitude and acceleration, acoustic ranges, and depth via the instrumented cable 50 to the vessel 100. The vessel 100 has continuous GNSS-position, UTC/ephemerides, acoustic telemetry, and shape for instrumented cable, which results in that it can send position estimates for control device from GNSS and acoustics, and UTC and ephemerides to the control device via the instrumented cable 50, in addition to the known settings and data being used for controlling the instrumented cable.

A method for high-accurate determination of position for a control device includes determining position and velocity of the control device 20 by means of a GNSS-unit arranged in at least one wing 22 of the control device and satellite-based navigation systems.

The method can further include an initial step including determining global position of the control device 20 and instrumented cable 50 as it is spooled out from the vessel 100. This position can further be used for initializing the local integrated position filter 70 in the control device 20 which is an integration of position and acceleration data.

The method further includes bringing a desired control device 20 up to surface position for communication with GNSS-satellite(s) 110 for determining position and velocity in a limited time before the control device 20 is brought down to operational depth again.

The method can further include arranging wing 22 with GNSS-unit of the control device so that it points mainly straight up from the surface when the control device 20 is in surface position. The method can also include arranging the control device 20 so that another wing 22 thereof provided with acoustic communication means 24 points down in the water.

As the control device is in surface position the method can further include data transfer to/from the control device 20 by means of the radio unit of the control device, preferably between vessel and control device, but also between work boats and control device. This data transfer can e.g. be orbit data for the satellites, clock and approximate position, so-called aiding data, something which will reduce the time the control device must be in surface position. It should be mentioned that transfer of aiding data to GNSS-receiver also can be performed periodically via instrumented cable protocol while the control device(s) is/are submerged. The GNSS-unit will then already be charged and ready to find satellites, as it breaks the water surface. The control device 20 can in surface position also transfer data via radio for relevant purposes, e.g. transfer its own position via radio when it is in surface position. E.g. the position information can be used to find the control device from a work boat, possibly find a wing which has been detached from the control device.

The method further includes supplying differential correction signals from a high-accurate positioning source onboard the survey vessel 100 by means of data transfer via the instrumented cables 50 or via the radio unit directly to the control devices 20 when they are in surface position.

The method further includes, when the control device 20 is not in contact with GNSS-satellites, updating the integrated position filter 70 ballistically with acceleration data (a priori data) from inertial cluster 60 arranged in at least one wing 22 of the control device 20, until new position data are available.

In addition the method preferably includes, in submerged state of the instrumented cable, acoustic range measurements between nodes/control devices 20 in the network by means of acoustic communication means 24 in at least one wing 22 of the control device 20.

The method further includes combining the measured acoustic range data from the control devices 20 with global telemetry on the vessel 100 for determining relative positions for each node.

The method further includes determining absolute positions for nodes/control devices based on the relative positions and navigation data of the vessel 100.

The method further includes using the absolute positions for new a posteriori position data in the integrated position filter 70.

The method further includes that the control devices 20/nodes calculate their own orientation (roll, pitch, course) based on data from the inertial cluster 60 and magnetometer 50, and possibly use of the orientation of the nodes in a central calculation on the vessel 100 for estimating shape of the instrumented cable 50.

The method further includes tightening the position estimates for the instrumented cables 50 during seismic by bringing entire or parts of an instrumented cable 50 to the surface at the same time as the instrumented cables 50 on each side of the relevant instrumented cable 50 are brought closer laterally, so that geographical holes in the seismic data do not occur.

The method further includes using GNSS-position and velocity of the control device in combination with acoustic measurements when wing of the control device provided with GNSS-unit points up from the sea; i.e. is in air, at the same time as a wing provided with acoustic communication means points down; i.e. is submerged in water, for calibrating the sound velocity in water.

The method further includes using previous knowledge about in-line distances between the nodes together with in-line range measurements for tightening the sound velocity estimate. This can be done by least square method where in-line range measurements are weighted higher than the remaining range measurements.

The method further includes using acoustic range measurements of reflections from water surface or seabed for integrity/calibration of depth sensor.

The method further includes arranging a control device 20 with GNSS-unit in at least one wing 22 at the tail of the instrumented cable 50 for replacing the tail buoy.

The method further includes arranging at least one control device 20 with GNSS-unit in at least one wing 22 close to the middle of the instrumented cable 50.

The method further includes arranging GNSS-unit in all control devices 20 for the instrumented cables 50.

As an alternative to control devices where everything is integrated in the wings, control devices including motor and drive gear housings can be used, preferably three motor and drive gear housings, which motor and drive gear housings are provided with wings, which motor and drive gear housings are provided with processor unit, inductive connection or mechanical connection for connection to the main body, Hall effect sensor, chargeable batteries, intelligent charging electronics, motor with gear, where at least one of the wings is provided with transmitter and receiver elements and electronics for acoustic range measurement.

1-28. (canceled)

29. A method for accurate determination of position of instrumented cables (50), or an instrumented towed cable-array (streamer-array), to which instrumented cable (50) control devices (20) with at least two wings (22) are arranged for controlling the shape and position of individual instrumented cables (50) in relation to other instrumented cables (50) and counteracting crosscurrents or other dynamic forces acting on a cable-array towed behind a seismic survey vessel (100), comprising:
bringing a control device (20) provided with a GNSS-unit in at least one wing (22) to a position for communication with GNSS-satellites (110) and arranging the at least one wing (22) including GNSS-unit substantially straight up from the surface to define the surface position,
positioning another wing (22) of the control device (20) having an acoustic transmitter and receiver element to point down in the water when the control device (20) is in the surface position, and
simultaneously performing determination of position and velocity of the control device (20) and range measurements between control devices (20).

30. The method of claim 29, comprising bringing a desired control device (20) up in surface position for communication with GNSS-satellites (110) for determining position and velocity in a limited time period before the control device (20) is brought down to operational depth again.

31. The method of claim 29, comprising the step of transferring data to or from the control device (20) via a radio unit arranged in at least one wing (22) of the control device when the control device (20) is in surface position.

32. The method of claim 31, wherein the step of transferring data includes transfer of aiding data, hereunder orbit data of the GNSS-satellites (110), clock and approximate position.

33. The method of claim 29, comprising acquiring differential correction signals from a high-accurate positioning source onboard the survey vessel (100) via data transfer via the instrumented cables (50) or via the radio unit directly to the control devices (20) when they are in surface position.

34. The method of claim 29, comprising updating an integrated position filter (70) in the control device (20) ballistically with acceleration data (a priori data) from an inertial cluster (60) arranged in at least one wing (22) of the control device (20) until new position data are available when the control device (20) is not in contact with GNSS-satellites (110).

35. The method of claim 29, comprising performing acoustic range measurements between control devices in the network via acoustic transmitter and receiver element arranged in at least one wing (22) of the control device when the instrumented cable is in a submerged state.

36. The method of claim 35, comprising combining the measured range data from the control devices (20) with global telemetry on the vessel (100) for determining relative positions for each control device.

37. The method of claim 36, comprising determining absolute positions for the control devices based on the relative positions and navigation data of the vessel (100).

38. The method of claim 37, comprising using the absolute positions for new a posteriori position data in the integrated position filter (70).

39. The method of claim 29, comprising calculating orientation of the control devices (20) based on inertial data from an inertial cluster (60) and a magnetometer (50) arranged in at least one wing (22), and optionally estimating the shape of the instrumented cable utilizing orientation of the control devices in a central calculation on the vessel.

40. The method of claim 29, comprising tightening position estimates for the instrumented cables (50) by bringing at least part of an instrumented cable (50) to the surface at the same time as the instrumented cables (50) on each side of the relevant instrumented cable (50) are brought closer together laterally, so that geographic holes in the seismic data do not occur.

41. The method of claim 29, comprising:
arranging a control device (20) with GNSS-unit in at least one wing (22) at the tail of the instrumented cable (50) instead of a tail buoy,
arranging at least one control device (20) with GNSS-unit in at least one wing (22) close to the middle of the instrumented cable (50),
arranging GNSS-unit in at least one wing (22) of all control devices (20) for the instrumented cable (50), or
a combination thereof.

42. The method of claim 29, comprising an initial step of determining global position of the control device (20) as the control device (20) and instrumented cable (50) are spooled out from the vessel (100).

43. The method of claim 29, comprising using GNSS-position and velocity of the control device in combination with acoustic range measurements when the wing of the control device provided with GNSS-unit is pointing up above the surface, at the same time as a wing provided with an acoustic communication transmitter and receiver element is pointing downward below the surface for calibrating the sound velocity in water.

44. The method of claim 29, comprising using previous information about in-line distance between the control devices together with in-line range measurements for tightening the sound velocity estimate.

45. The method of claim 29, comprising using acoustic range measurements of reflections from water surface or seabed for integrity or calibration of depth sensor.

46. A system for accurate determination of position of seismic instrumented cables (50), or an instrumented towed cable-array (streamer-array), to which instrumented cable (50) control devices (20) with at least two wings (22) are arranged for controlling the shape and position of the instrumented cables (50), in relation to other instrumented cables (50) and counteracting crosscurrents or other dynamic forces acting on a cable-array towed behind a seismic survey vessel (100), wherein at least one control device (20) for the instrumented cable(s) (50) is provided with a GNSS-unit in at least one wing (22) of the control device (20) and an acoustic transmitter and receiver element, in the form of a transducer, and provided with electronics for acoustic range measurement,
wherein the control device (20) is controllable for arranging the at least one wing (22) including GNSS-unit substantially straight up from the surface and arranging another wing (22) thereof including an acoustic transmitter and receiver element so that it points down in the water for simultaneously performing determination of position and velocity of the control device (20) and range measurements between control devices (20) to define a surface position.

47. The system of claim 46, wherein the GNSS-unit includes a GNSS-antenna (31) and GNSS-receiver (32).

48. The system of claim 47, wherein the GNSS-antenna (31) is arranged in the wing tip.

49. The system of claim 46, wherein the control device (20) includes a radio unit, comprising a radio antenna (41) and radio receiver (42) for data transfer, which radio unit is arranged in at least one wing (22) of the control device (20).

50. The system of claim 49, wherein the radio antenna (42) is arranged along the edge of the wing (22) facing substantially forward in the direction of towing.

51. The system of claim 46, wherein the control device (20) includes a three-axis magnetometer (50) in at least one wing (20) thereof, the magnetometer (50) being arranged close to the wing tip.

52. The system of claim 46, wherein the control device (20) includes an inertial cluster (60) including one or more accelerometers and optionally rate gyro, in at least one wing (22) thereof.

53. The system of claim 46, wherein the control devices (20) include a position filter (70) integrated in a processor unit in at least one wing (22) thereof.

54. The system of claim 46, wherein the survey vessel (100) is provided with a central control unit provided with a position estimator (80).

55. The system of claim 46, wherein:
the control device (20) with GNSS-unit in at least one wing (22) is arranged at the tail of the instrumented cable (50) instead of a tail buoy,
at least one control device (20) with GNSS-unit in at least one wing (22) is arranged close to the middle of the instrumented cable (50), or
all the control devices (20) for the instrumented cable includes at least one wing (22) with GNSS-unit, or
a combination thereof.
